(19) United States
(12) Patent Application Publication
(10) Pub. No.: US 2017/0322547 A1
(43) Pub. Date: Nov. 9, 2017

(54) Processing Apparatus

(71) Applicant: FACTORY AUTOMATION TECHNOLOGY CO., LTD., Chiayi County (TW)

(72) Inventors: PO CHENG SU, Chiayi County (TW); Hsin Hong Hou, Chiayi County (TW); Fan Tien Cheng, Chiayi County (TW); Haw Ching Yang, Chiayi County (TW); Hao Tieng, Chiayi County (TW)

(21) Appl. No.: 15/587,351

(22) Filed: May 4, 2017

(30) Foreign Application Priority Data
May 4, 2016 (TW) 105206395

(51) Int. Cl. G05B 19/418

(52) U.S. Cl. CPC G05B 19/4188; G05B 2219/31001; G05B 2219/32194

(57) ABSTRACT

A processing apparatus includes a central control unit, and a processing quality prediction unit, a processing unit, and a tool compensation unit which are respectively connected with the central control unit electrically. The processing quality prediction unit implements a virtual processing quality prediction method to predict the processing quality of the workpiece, output an accurate data of quality to the central control unit, and generate tool path for the processing unit to process the workpiece. The central control unit judges the data from the processing quality prediction unit and outputs the data to the tool compensation unit to calculate tool compensation data. The tool compensation unit provides the tool compensation data to the processing quality prediction unit to form a new processing path. Then the processing unit implements the compensated processing path to process the workpiece.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a processing apparatus, and more particularly to a processing apparatus that can automatically conduct tool compensation for altering the processing path.

### Description of Related Arts

In order to upgrade the efficiency and quality of workpiece processing, the industry utilizes numerical controlled digital processing apparatus as processing machine. After the workpiece is designed, the designed data and processing parameters are directly converted into processing path of the workpiece by, for example, a device that combines Computer-Aided Design (CAD) and Computer Aided Manufacturing (CAM). Although such CAD-CAM manufacturing device can achieve a certain stable quality and process efficiency, it can not effectively predict the processing quality of each workpiece during the processing. As a result, the processing quality of the processed workpiece, such as the dimension, roughness, and etc. can only be additionally measured with measurement device, which takes time and increases defect rate of the workpiece because by the time a dimension issue or other processing quality issue is found, there are many defective workpiece produced already. In order to deal with the drawback that the processing quality cannot be immediately detected during the processing of the workpiece, a prediction method of processing quality of workpiece was invented, which could utilize conventional numerical controlled processing apparatus to effectively improve on the above drawback. The prediction method of processing quality of workpiece is disclosed in Taiwan Patent Number TWI481978B, entitled “Method for predicting machining quality of machine tool” (claiming priority of U.S. Patent Application No. 61/722,250). Although this prediction method of processing quality of workpiece is able to directly predict processing quality and modify the processing path during the processing, nevertheless, in terms of processing tool compensation, it still relies on experiences of operation personnel to manually and timely input tool compensation data to modify or correct the processing path of the workpiece. Such way that relies on experiences of operation personnel to determine tool compensation data and manual inputting can easily affect the processing accuracy. Therefore, the present invention mainly aims to improve on the drawbacks of manual tool compensation practice.

### SUMMARY OF THE PRESENT INVENTION

Therefore, an object of the present invention is to provide a processing apparatus that can automatically conduct tool compensation for generating at least a new processing path.

Accordingly, the processing apparatus according to the present invention comprises a central control unit, and a processing quality prediction unit, a processing unit and a tool compensation unit which are respectively connected with the central control unit electrically. The processing quality prediction unit implements a virtual processing quality prediction method to predict the processing quality of the workpiece, output an accurate data of quality to the central control unit, and generate tool path for the processing unit to process the workpiece. The central control unit judges the data from the processing quality prediction unit and outputs the data to the tool compensation unit to calculate tool compensation data. The tool compensation unit provides the tool compensation data to the processing quality prediction unit to form a new processing path. Then the processing unit implements the compensated processing path to process the workpiece. Based on the above, the processing apparatus combines the processing quality prediction unit and the tool compensation unit and utilizes the central control unit as the control interface of these units, in order to automatically and effectively generate new tool compensated processing paths, which replaces the operations that rely on experiences of operation personnel or conduct tool compensation after manual measurements, and effectively achieves better processing efficiency.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram illustrating a processing apparatus according to the present invention.

### DETAILED DESCRIPTION OF THE PREFERRED EMBODIMENT

The following description is disclosed to enable any person skilled in the art to make and use the present invention. Preferred embodiment is provided in the following description only as an example and modifications will be apparent to those skilled in the art. The general principles defined in the following description would be applied to other embodiments, alternatives, modifications, equivalents, and applications without departing from the spirit and scope of the present invention.

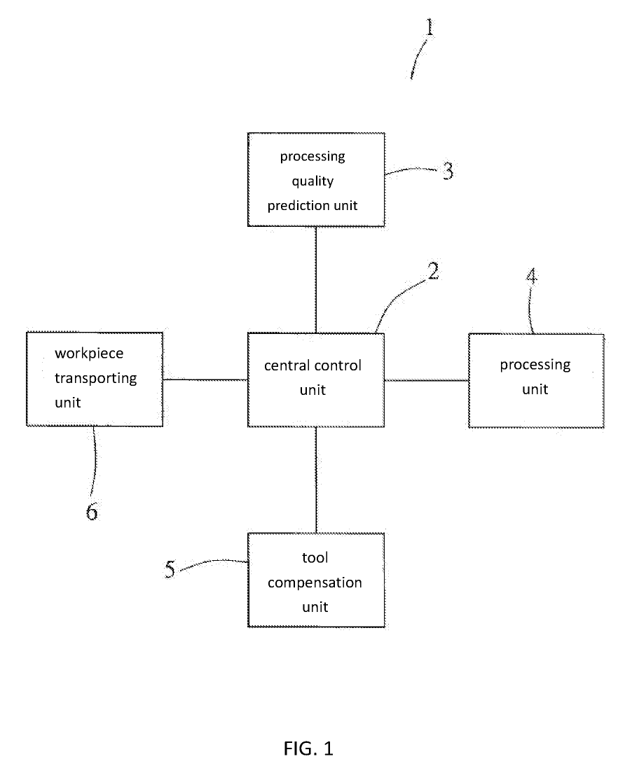

Referring to FIG. 1, the processing apparatus 1 according to a preferred embodiment of the present invention is utilized to process a workpiece. The processing apparatus 1 comprises a central control unit 2, and a processing quality prediction unit 3, a processing unit 4, a tool compensation unit 5, and a workpiece transporting unit 6 which are respectively connected with the central control unit 2 electrically. The processing quality prediction unit 3 utilizes the technology disclosed in Taiwan Patent Number TWI481978B, entitled “Method for predicting machining quality of machine tool.” It mainly applies Computer-Aided Design (CAD) to produce the outline, dimensions, and tolerance of the workpiece and uses Computer Aided Manufacturing (CAM) to generate processing path based on the above dimensions and tolerance as well as the characteristics of the processing unit 4. Also, when the processing quality prediction unit 3 establishes the quality prediction model, at least a product accuracy category has to be assigned. The product accuracy category comprises roughness and/or dimension deviation, and etc. The dimension deviation comprises straightness, angularity, perpendicularity, parallelism, and/or roundness, etc. The product accuracy category is associated with the processing path so as to provide a plurality of relevancies between the product accuracy category and the processing path. Then, the processing unit 4 will be utilized to process multiple workpieces according to the processing path to produce workpiece samples and to collect multiple sets of sample detection information of the multiple workpiece samples 3 relate to the processing path during the processing period. After the operation of sampling, it utilizes algorithm to control the noise of the detection information and convert the detection information of workpiece sample into sample characteristic data in correspondence with characteristic format. After the processing of workpiece sample is finished, the product accuracy category(ies) of the workpiece sample is measured so as to obtain a set of quality sample data (value of accuracy). Then the quality sample data and the characteristic data of the workpiece sample are utilized to predict the interrelation between the algorithm and processing path and the product accuracy category, in order to build a prediction model for the product accuracy category. Namely, the characteristic data, quality sample data, and accuracy of workpiece, that are obtained when the processing unit 4 processed the workpiece sample, are utilized to form a prediction model. Also, accurate data of quality is output to the central control unit 2 at the same time.

The central control unit 2 judges the data from the processing quality prediction unit 3 first and then outputs the data to the tool compensation unit 5 to calculate tool compensation data. After the tool compensation unit 5 calculated the new tool compensation data, the tool compensation unit 5 will provide the tool compensation data to the processing quality prediction unit 3 to form at least a new processing path. Then the processing unit 4 implements the compensated processing path to process the workpiece. The workpiece transporting unit 6 is for transporting the workpiece to or from the processing unit 4. The workpiece transporting unit 6 is embodied as a robot arm, which can also transmit the feature information of the workpiece being transported, such as that it is transporting the workpieces of the model of Area A, to the central control unit 2. Such feature information will be paired with corresponding tool compensation data and be stored together in the central control unit 2. That is to say, when the model of workpiece is to be processed by the processing unit 4, its tool compensation data will be retrieved for reference and utilization.

The processing apparatus 1 according to the present invention processes target workpieces like the following. The processing quality prediction unit 3 generates processing path based on the information of the design. The workpiece transporting unit 6 transports the workpiece to the processing unit 4 for processing. The workpiece transporting unit 6 immediately records the feature information of the workpiece being transported. After the workpiece is processed, it will be transported to a storage position by the workpiece transporting unit 6. During the processing, all kinds of data or information of the quality of the workpiece are tested at the same time to predict the quality of the workpiece. If the quality of the workpiece is not qualified, the processing quality prediction unit 3 will immediately correct it and generate a new processing path, so as to greatly reduce the defect rate of the workpiece and improve on the timeliness of the workpiece quality measurement. Then the processing quality prediction unit 3 will provide accurate data of the detected workpiece quality to the central control unit 2. The central control unit 2 determines and sends reliable data to the tool compensation unit 5. The tool compensation unit 5 calculates the data of required tool compensation based on the data of the original designed quality or dimensions of the workpiece and transmits the data of required compensation to the processing quality prediction unit 3 for generating new processing path. A new workpiece will then be processed based on the compensated processing path, so as to ensure the stability of the workpiece processing quality.

The processing apparatus 1 according to the present invention combines both the processing quality prediction unit 3 and the tool compensation unit 5 and utilizes the central control unit 2 as the interface of the connection of the above two units, such that the apparatus can automatically and effectively generate new and tool compensated processing path, which replaces the operations that rely on experiences of operation personnel or conduct tool compensation after manual measurements, and effectively achieves better processing efficiency. Also, it utilizes the workpiece transporting unit 6 to record feature information of the workpiece being transported, so as to combine the data of tool compensation and the feature information of the workpiece for the future processing of the workpiece of the feature information.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A processing apparatus for a workpiece, comprising:
a central control unit;
a processing quality prediction unit;
a processing unit; and
a tool compensation unit, wherein said processing quality prediction unit, said processing unit and said tool compensation unit are respectively connected with said central control unit electrically, wherein said processing quality prediction unit implements a virtual processing quality prediction method to establish a quality prediction model to predict a processing quality of the workpiece, output an accurate data of quality to said central control unit, and generate at least a tool path for said processing unit to process the workpiece, wherein said central control unit judges data from said processing quality prediction unit and outputs said data to said tool compensation unit to calculate tool compensation data, wherein said tool compensation unit provides said tool compensation data to said processing quality prediction unit to form a new processing path, wherein said processing unit implements a compensated processing path to process the workpiece.

2. The processing apparatus, as recited in claim 1, further comprising a workpiece transporting unit connected with said central control unit electrically, wherein said workpiece transporting unit transports the workpiece to said processing unit for processing and sends an information of workpiece transportation to said central control unit.

3. The processing apparatus, as recited in claim 2, wherein said workpiece transporting unit is a robot arm.
